(19) United States
(12) Patent Application Publication
(10) Pub. No.: US 2009/0245876 A1
(43) Pub. Date: Oct. 1, 2009

(54) ELECTROPHOTOGRAPHIC TONER AND IMAGE FORMING APPARATUS

(75) Inventors: Nobuo Tohata, Shizuoka (JP); Hisanobu Ajima, Kanagawa (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/411,420

(22) Filed: Mar. 26, 2009

Related U.S. Application Data
(60) Provisional application No. 61/040,886, filed on Mar. 31, 2008.
(60) Provisional application No. 61/040,892, filed on Mar. 31, 2008.

(51) Int. Cl. G03G 15/08; G03G 9/08

(52) U.S. Cl. 399/252; 430/108.7

(57) ABSTRACT

According to an embodiment of the invention, an electrophotographic toner contains 100 parts by weight of a toner resin, from 0.01 to 10 parts by weight of a cyclodextrin compound, first silica having an average particle diameter of from 20 to 40 nm, and second silica having an average particle diameter of from 8 to 14 nm.

### CROSS-REFERENCE TO RELATED APPLICATION

This application is based upon and claims the benefit of priority from the prior U.S. Patent Application No. 61/040,886 filed on Mar. 31, 2008 and the prior U.S. Patent Application No. 61/040,892 filed on Mar. 31, 2008, the entire contents of which are incorporated herein by reference.

### TECHNICAL FIELD

The present invention relates to an electrophotographic toner and an image forming apparatus used for forming an image by electrophotography.

### BACKGROUND

A toner-recycling electrophotographic apparatus reusing a powder toner is receiving attention for such purposes as environmental protection. In the apparatus, a toner remaining on a photoconductive drum is recovered with a cleaner, and the recovered toner is returned to a developing device for repeated reuse of the toner. An external additive dropped off from the toner surface is accumulated in the developing device by the repeated use. In particular, when the amount of titanium oxide used for ensuring image density under a low temperature environment exceeds a certain amount, the charge amount is weakened or reverse charging occurs owing to the low resistance thereof, which appears as fogging on paper, to cause image failure, thereby deteriorating the service life of the apparatus.

It is being known to use silica as an external additive for a toner, and silica having a small particle diameter is used for providing an image with high quality. Silica having a small particle diameter is however embedded on the toner surface particularly under a low temperature environment or a low humidity environment to lower the flowability of the developer, and the charge amount is lowered to cause fogging.

For the purpose of prolonging the service life of the apparatus, it is preferred to use a salt compound type charge controlling agent (CCA), which has a function of suppressing the charge amount from being fluctuated, rather than a conventional metallic complex charge controlling agent. For example, a toner containing a cyclodextrin (polysaccharide) compound as a charge controlling agent is known (see, for example, JP-A-10-186729).

However, the cyclodextrin compound is liable to provide a high charge amount and is difficult to manage charge control, and thus is difficult to provide images with stable quality.

### SUMMARY

An object of the invention is to provide an electrophotographic toner that provides an image with high quality and is suitable for an electrophotographic apparatus having a prolonged service life.

The invention relates to, as an aspect, an electrophotographic toner containing 100 parts by weight of a toner resin, from 0.01 to 10 parts by weight of a cyclodextrin compound, first silica having an average particle diameter of from 20 to 40 nm, and second silica having an average particle diameter of from 8 to 14 nm.

According to the aspect of the invention, silica having a large particle diameter (i.e., the first silica having an average particle diameter of about from 20 to 40 nm) is used in addition to silica having a small particle diameter (i.e., the second silica having an average particle diameter of about from 8 to 14 nm) as an external additive, and a cyclodextrin compound is used as a charge controlling agent. Accordingly, the silica having a small particle diameter is agitated with the silica having a large particle diameter, whereby the flowability is prevented from being lowered, and the charge amount of the silica having a small particle diameter is suppressed from being lowered. Furthermore, increase of the charge amount due to the cyclodextrin compound as a charge controlling agent can be suppressed by spacing effect of the silica having a large particle diameter.

### DESCRIPTION OF THE DRAWINGS

FIG. 1 is a schematic illustration showing an image forming apparatus using a toner recycling system according to one embodiment of the invention.

FIG. 2 shows tables showing experimental results of comparison of the toners of Examples and Comparative Examples.

FIG. 3 shows a general formula of cyclodextrins.

FIG. 4 shows a formula of α-cyclodextrins.

FIG. 5 shows a formula of β-cyclodextrins.

FIG. 6 shows a formula of γ-cyclodextrins.

FIG. 7 shows a three-dimensional structure of cyclodextrins.

FIG. 8 shows the formula of the zirconium complex.

### DETAILED DESCRIPTION

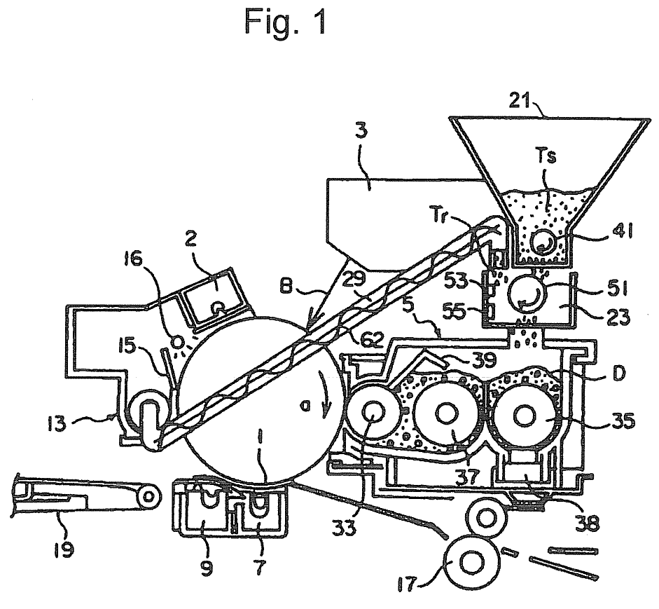

The electrophotographic toner according to the invention will be described as an embodiment where the toner is applied to a duplicator using a toner recycling electrophotographic system with reference to the drawing. FIG. 1 is a schematic cross sectional view showing an important part of the duplicator of the embodiment.

The important part of the duplicator shown in FIG. 1 has a photoconductive drum 1 as an image carrying member. The photoconductive drum 1 rotates in the direction shown by the arrow a in the figure.

A charger 2, an exposing device 3 that forms an electrostatic latent image on the charged photoconductive drum 1 by exposing with a laser beam B, a developing device 5 that develops the electrostatic latent image, a transferring device 7 that transfers a developer image to paper, a releasing device 9 that releases the paper from the photoconductive drum 1, a cleaning device 13 that cleans the remaining developer on the photoconductive drum 1, and the like are disposed around the photoconductive drum 1. The cleaning device 13 contains a cleaning blade 15 that in contact with the photoconductive drum to remove the developer on the photoconductive drum, and a destaticizing lamp 16 that destaticizes the photoconductive drum 1 after removing the developer.

The paper is fed from a paper feeding cassette, which is not shown in the figure, and conveyed to the photoconductive drum 1 with a conveying roller 17 and the like. The paper having the developer image transferred thereon from the photoconductive drum with the transferring device 7 is conveyed to a fixing device, which is not shown in the figure, with a conveying belt 19.

The developing device 5 contains a developer D as an initial developer. The developer D is a two-component developer constituted by a toner and a carrier. The developer D will be described in detail later.

A toner replenishing unit 21 that contains a developer replenisher for replenishing the initial developer consumed through development is disposed above the developing device 5. A toner mixing unit 23 is disposed between the toner replenishing unit 21 and the developing device 5. A recycling device 29 that feeds the used developer, which is recovered with the cleaning device 13, to the toner mixing unit 23 for reusing the developer is provided between the toner mixing device 23 and the cleaning device 13.

The developing device 5 contains the developer D containing a toner and a carrier as an initial developer, and furthermore contains a developing roller 33 facing the photoconductive drum. The developing device 5 has provided inside an agitating roller 35 that agitates the developer D in the developing device 5, and a feeding roller 37 that feeds the developer agitated with the agitating roller 35 to the developing roller 33. A sensor 38 that determines the mixing ratio of the toner and the carrier in the developing device 5 by means of magnetic permeability is disposed under the agitating roller 35. A doctor blade 39 that forms a thin layer of the developer D, which is fed from the feeding roller 37, on the developing roller is disposed to face the developing roller 33.

The toner replenishing unit 21 contains inside a toner replenisher Ts. The toner replenishing unit 21 has a toner replenishing roller 41 that feeds the toner to the toner mixing unit 23. A suitable amount of the toner Ts contained in the toner replenishing unit 21 is dropped into the toner mixing unit 23 through rotation of the toner replenishing roller 41.

The toner Ts is replenished to the toner mixing unit 23, and furthermore, a recycled toner Tr, which is conveyed with the recycling device 29, is fed to the toner mixing unit 23. The toner mixing unit 23 has a mixing roller 51 that mixes and agitates the toner Ts and the recycled toner Tr. The toner mixing unit 23 has inside a sensor 53 that detects the toner amount in the toner mixing unit 23. The toner replenishing roller 41 is rotationally drive based on the detection result of the toner amount obtained from the sensor 53. The mixing roller 51 is rotated based on the detection result of the toner amount obtained from the sensor 38 to feed the toner in the mixing unit 23 to the developing device 5.

The recycling device 29 contains a conveying auger 62, and the developer removed with the cleaning blade 15 is conveyed to the toner mixing unit 23 through rotation of the conveying auger 62.

The developer D will be described in detail. The developer D as an initial developer is constituted by a toner and a carrier that are in the powder form, and the developer D is housed in the developing device 5. The toner T contains toner particles containing a resin, a colorant, such as carbon black, a charge controlling agent, wax and the like, and also contains two kinds of silica having different particle diameters that are externally added to the surface of the toner particles, and titanium oxide as another external additive.

A cyclodextrin compound is used as the charge controlling agent. One kind of the silica is silica having a large particle diameter (first silica) having an average particle diameter of from 20 to 40 nm, and the other one kind of silica is silica having a small particle diameter (second silica) having an average particle diameter of from 8 to 14 nm. The charge controlling agent and the silica will be described in detail later.

The amount of titanium oxide contained in the toner particles is preferably from 0.15 to 1.2 parts by weight per 100 parts by weight of the toner, as described later.

The toner replenisher Ts is constituted by a resin, a colorant, a charge controlling agent, wax, silica and the like, as similar to the toner T constituting the developer D, and is replenished into the toner replenishing unit 21 depending on necessity.

The toner may be produced, for example, in the following manner. A resin, a colorant (e.g., carbon black as a pigment), a cyclodextrin compound as a charge controlling agent, titanium oxide and wax are kneaded in a molten state, and the resulting mixture is cooled, pulverized and classified to provide toner particles having a diameter of about 10 μm. The two kinds of silica are added to the toner particles to produce a toner. The carrier is not particularly limited, and in this embodiment, a ferrite carrier is used as the carrier.

The operation of the image forming apparatus thus constituted will be described.

The photoconductive drum 1 is rotated and charged with the charger 2, and the charged photoconductor drum 1 is exposed with a laser beam B corresponding to an image from the exposing device 3, thereby forming an electrostatic latent image. The electrostatic latent image is then developed with the developer D housed in the developing device 5. The developer image thus formed on the photoconductor drum is transferred to paper with the transferring device 7, and the paper is released from the photoconductor drum 1 through charge applied from the releasing device 9, and conveyed with the conveying belt 19.

The developer remaining on the photoconductive drum 1 after transferring the developer image is removed with the cleaning blade 15. Thereafter, the photoconductive drum 1 is destaticized with the destaticizing lamp 16 to complete one cycle of image formation, and then again charged with the charger 2.

The developer D in the developing device 5 is consumed through the image formation, and the mixing ratio of the toner and the carrier that is fluctuated through the consumption is detected by the sensor 38. The toner is replenished from the toner mixing unit 23 to the developing device 5 based on the detection result of the sensor 38.

In the toner mixing unit 23, the sensor 53 detects the toner amount, and the toner Ts is replenished to the toner mixing unit 23 from the toner replenishing unit 21 based on the detection signal of the sensor 53.

The toner Tr removed with the cleaning blade 15 is fed to the toner mixing unit 23 through rotation of the conveying auger 62 in the recycling device 29. Accordingly, the toner that is fed from the toner mixing unit 23 to the developing device 5 is a mixture of the toner Ts and the toner Tr.

After starting the image formation, the toner T is attached to the photoconductor drum 1, which is slidingly in contact with the cleaning blade in such a state that the toner is attached to the photoconductor drum. Degradation of the carrier proceeds along with progress of the image formation.

The silica as an external additive for the toner particles will be described.

The silica <A> is preferably used the silica surface treated by Dimethyldichlorosilane (DDS), for example, R-976 or R-974 made by JAPAN AEROSIL.

The silica <B> is preferably used the silica surface treated by Hexamethyl disilazane (HMDS), for example, NAX-50 or RX-50 made by JAPAN AEROSIL.

The developer preferably contains toner particles having a 50% volume average particle diameter (50 Dvol) of from 6 to 10 μm and a specific resistance of from 13¹⁰ to 20¹⁰ Ω·cm and a carrier having a 50% volume average particle diameter (50 Dvol) of from 30 to 50 μm. The toner particles preferably contains furthermore the second silica <A> having an average particle diameter of from 8 to 14 nm and the first silica <B> having an average particle diameter of from 20 to 40 nm, and the ratio of the addition amounts (percentages by weight) thereof <B>/<A> is preferably from 1 to 50.

A fogging test was performed with the aforementioned toner recycling duplicator with variation of the particle diameters of the two kinds of silica, <A> and <B> having different particle diameters, the addition amounts (percentage by weight) of the silica, the ratio <B>/<A> of the silica, the particle size distribution of the toner, the amount (percentage by weight) of titanium oxide, the kind of the charge controlling agent (CCA), the change in charge amount (ΔμC) and the like.

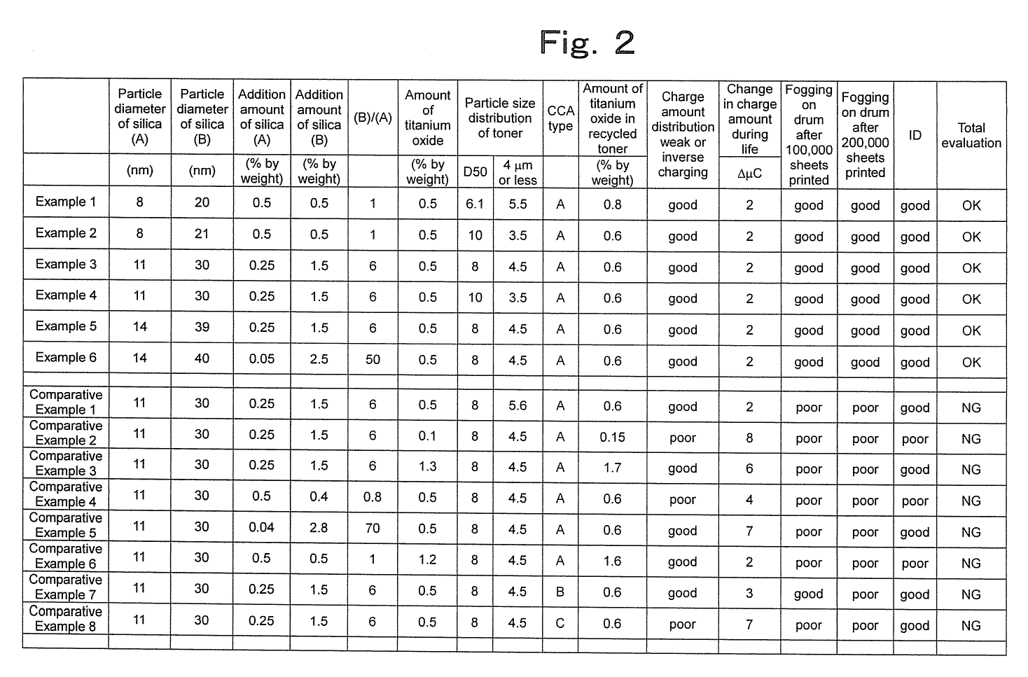

The toner used in Example 1 shown in FIG. 2 was produced in the following manner.

The following raw materials for the toner particles were prepared.

| | | |
|---|---|---|
| (1) | styrene-acrylic resin (glass transition point: 55.6° C., | 86 parts |
| | 150° C. melt index: 5 g/19 min) | |
| (2) | carbon black | 7.5 parts |
| (3) | CCA (type A described later) | 1.5 parts |
| (4) | polypropylene wax (melting point: 140° C.) | 3 parts |
| (5) | polyethylene wax (melting point: 99° C.) | 2 parts |

The components (1) to (5) were mixed and dispersed with a Henschel mixer, and the mixture was kneaded under a molten state with a biaxial extruder.

The coarsely pulverized product of the mixture was finely pulverized with a jet mill, and then classified with a separator to produce toner particles.

The following external additives were added to 100 parts of the resulting toner particles with a Henschel mixer to produce a toner.

### Formulation of External Additives (Based on 100 Parts of the Toner Particles)

| | |
|---|---|
| (a) silica <A> R-976 (described above) | 0.5 part |
| (b) silica <B> NAX-50 (described above) | 0.5 part |
| (c) titanium oxide | 0.5 part |

Toners of Examples 2 to 6 and Comparative Examples 1 to 8 were produced in the same manner as in Example 1 except that the particle diameters of the silica <A> and <B>, the addition amounts thereof, the ratio thereof, the amount of titanium oxide, the particle size distribution of the toner, and the like were changed as shown in the left side of FIG. 2.

The results of experiments are shown in the right side of FIG. 2. Images were obtained with a modified machine equipped with a transferring roller. Fogging was evaluated after printing 100,000 sheets and after printing 200,000 sheets.

The reflectivity on the white background of the paper was measured and compared to the reflectivity of fresh paper. When the difference in reflectivity was 1% or less, the toner was evaluated as “good”, and when the difference in reflectivity was 1% or more, the toner was evaluated as “poor”.

The silica <A> had an average particle diameter of from 8 to 14 nm, and the silica <B> had an average particle diameter of from 20 to 40 nm. The ratio of the silica <A> to the silica <B> <A>/<B> in terms of weight percentage was from 1 to 50% by weight. The addition amount of the silica <A> was from 0.05 to 0.5% by weight, and the addition amount of the silica <B> was from 0.5 to 2.5% by weight. The toner had a 50% volume average particle diameter (50 Dvol) of from 6 to 10 μm.

In FIG. 2, A indicates the experimental results when the cyclodextrin compound is used as a charge controlling agent.

In this case, the silica <A> had a particle diameter (50 Dvol) of from 8 to 14 nm, and the silica <B> had a particle diameter (50 Dvol) of from 20 to 40 nm. The mixing ratio of the silica <B>/<A> in terms of percentage by weight was from 1 to 50. The addition amount of titanium oxide to the toner was from 0.15 to 1.2 parts by weight per 100 parts by weight of the toner for suppressing fogging. The amount of titanium oxide in the recycled toner from the initial stage to the stage after printing 200,000 sheets was 1.5 parts by weight or less per 100 parts by weight of the toner.

As a result of measurement with a toner particle measuring apparatus (Coulter Multisizer), the particle diameter (50 Dvol) of the toner was from 6 to 10 μm, and the amount of fine powder in the toner was 5.5% by population or less in terms of amount of particles of 4 μm or less.

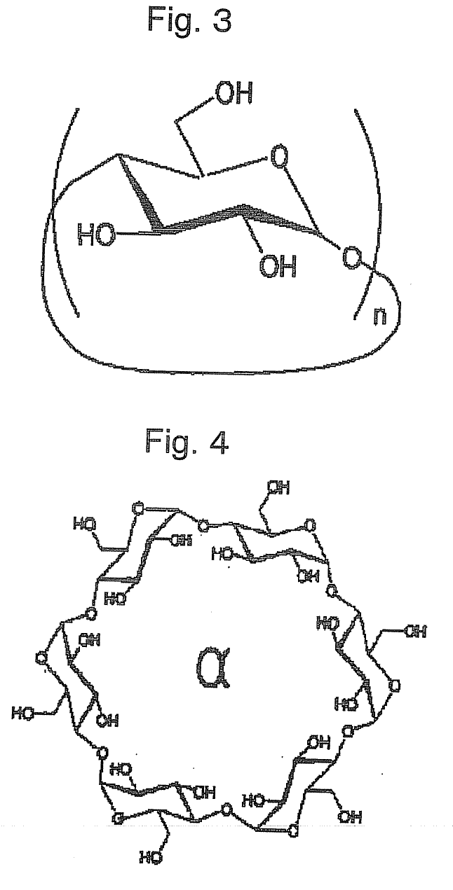

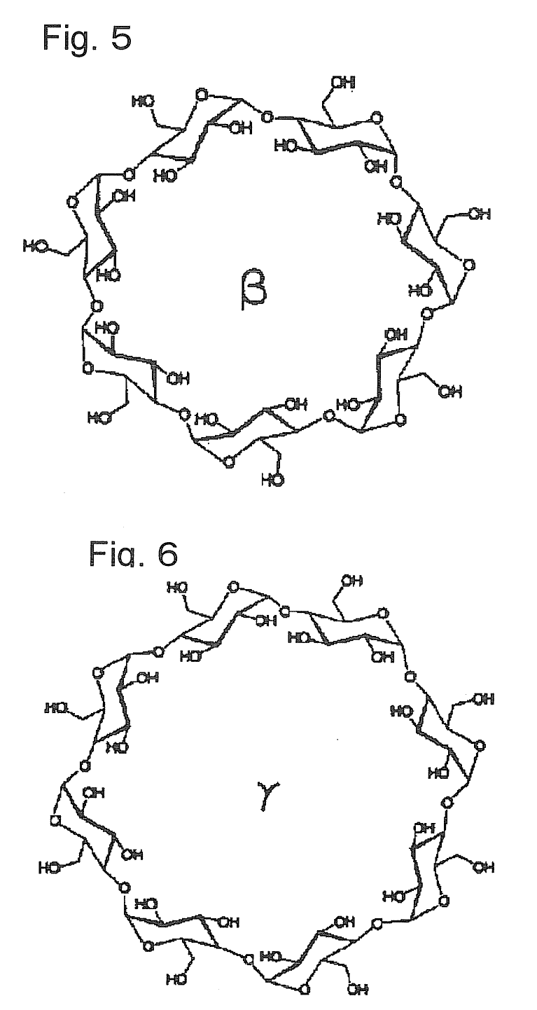

The column of “CCA type” in FIG. 2 will be described. FIG. 3 shows general formula of cyclodextrins. FIG. 4 shows a formula of α-cyclodextrins, FIG. 5 shows a formula of β-cyclodextrins, and FIG. 6 shows a formula of γ-cyclodextrins.

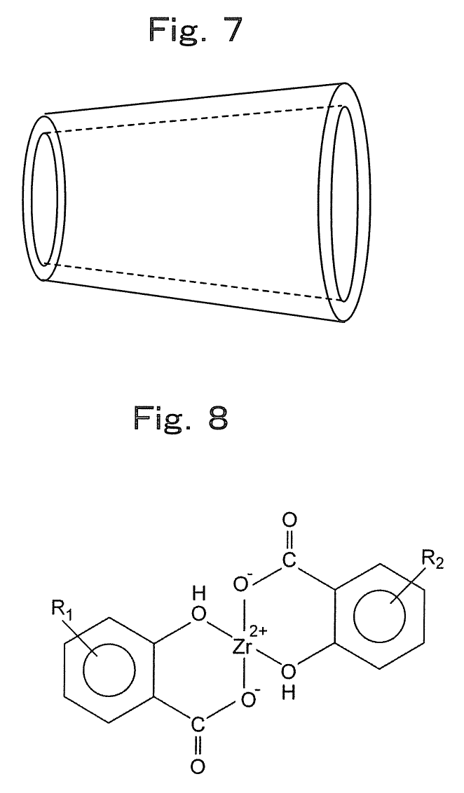

As shown in FIG. 7, cyclodextrins has a three-dimensional structure like a bottomless bucket. A ring part of formula shown FIGS. 4, 5 and 6 corresponds to the side of the bucket. A guest compound is taken into a follow aria of the bucket.

“A” in the column of “CCA type” in FIG. 2 indicates the case using as a charge controlling agent one of α-, β- and γ-cyclodextrins with a magnesium compound as a guest compound. “B” indicates the case using as a charge controlling agent one of α-, β- and γ-cyclodextrins with a silicon compound as a guest compound.

“C” indicates the case using as a charge controlling agent a zirconium complex. FIG. 8 shows the formula of the zirconium complex. One example of commercial product of the zirconium complex is TN-105 by HODOGAYA CHEMICAL CO., LTD.

The use of the cyclodextrin compound (polysaccharide compound) as a charge controlling agent decreases the weakly charged part in the charge amount distribution and suppresses fluctuation in charge amount during life.

The weak or inverse charging in the charge amount distribution in FIG. 2 means an area in which a charge amount is near zero or inverse by measurement of a charge amount measuring apparatus (E-spart Analyzer by HOSOKAWA MICRON Co.). When it was 5% or less after printing 200,000 sheets, the toner was evaluated as “good”, and when it exceeds 5%, the toner was evaluated as “poor”.

The change in charge amount during life (ΔμC) means the measured amount of suction blow-off. When the value obtained by subtracting the charge amount after printing 200,000 sheets from the charge amount after adjusting the toner function was 5 μC/g or less, the toner was evaluated as “good”. The charge amounts after adjusting the toner function and after printing 200,000 sheets were measured for the developers that were tested under the same conditions.

For using a prolonged service life, it is effective to use the cyclodextrin (polysaccharide) compound as a charge controlling agent that suppresses the charge amount from being fluctuated, as compared to a conventional metallic complex charge controlling agent.

The reasons therefor are as follows. Cyclodextrin contains a cyclic oligosaccharide in an annular form, and includes a guest in the void of the annular form to become a clathrate compound (cyclodextrin compound), which is structurally stable and is excellent in heat resistance and fusion resistance under friction.

Accordingly, when a cyclodextrin compound is used as a charge controlling agent in a toner, fusion to other substance due to friction and heat is suppressed, whereby charge failure due to spent of the toner on a carrier is suppressed to attain a prolonged service life. Cyclodextrin is also environmentally benign since it does not contain a heavy metal and is used in foods and the like.

Examples of the useful guest included in the void include a metallic cation, such as Li⁺, Na⁺, K⁺, Mg⁺, Ca²⁺, Sr²⁺, Ba²⁺, Ti²⁺, Ti⁴⁺, Zr²⁺, Zr⁴⁺, Cr³⁺, Cr⁶⁺, Mn²⁺, Mo⁴⁺, Fe²⁺, Fe³⁺, Ni²⁺, Cu⁺, Cu²⁺, Zn²⁺, Al³⁺, Si²⁺ and Si⁴⁺.

The guest is preferably a light metal since it is environmentally benign, and more preferably Mg²⁺ or Al³⁺.

The inorganic cation may be in an oxidized state. The inorganic cation may have coordinated thereto a neutral or anionic ligand, such as H₂O, Co, CN⁻, NH₃, OH⁻, O²⁻, Cl⁻, F⁻, Br⁻ and I⁻.

The particle diameter of the cyclodextrin compound as a charge controlling agent may be 1 μm or less for applying to a positively charging toner or may be in a range of from 1 to 10 μm with a particle size distribution that is as narrow as possible for applying to a negatively charging toner, as described in JP-A-10-186729. This is because the polarity thereof is changed at a particle diameter of 1 μm as the boundary.

The cyclodextrin compound or a derivative thereof has an electron attractive sulfonate ester group and thus is charged negatively by itself. Accordingly, the vicinity of the cyclodextrin derivative in the toner is charged positively since electrons are attracted by the cyclodextrin derivative. When the cyclodextrin derivative has a small particle diameter in the toner, the surface of the toner and the vicinity thereof contains a large proportion of a part that is positively charged owing to attraction of electrons by the cyclodextrin derivative. The proportion of the cyclodextrin derivative (negatively charged) that is exposed on the surface of the toner is thus decreased, and the toner is totally charged positively.

When the cyclodextrin derivative has a large particle diameter, on the other hand, the proportion of a part that is positively charged owing to attraction of electrons by the cyclodextrin derivative is decreased on the surface of the toner and the vicinity thereof. Accordingly, the proportion of the cyclodextrin derivative (negatively charged) that is exposed on the surface of the toner is thus increased, and the toner is totally charged negatively.

In the case of the toner of this type, the particle diameter of the charge controlling agent dispersed in the toner is fluctuated, whereby the charge amount distribution of the toner is broadened, and there is increased possibility that the proportion of the inversely charged toner is increased.

Accordingly, the charge controlling agent is preferably dispersed finely to a diameter of 1 μm or less for a positively charged toner, and the particle diameter of the charge controlling agent is preferably in a range of from 1 to 10 μm with a particle size distribution that is as narrow as possible for a negatively charging toner.

Examples of commercially available products of the cyclodextrin clathrate compound include Copy Charge N4P01, a trade name, available from Clariant Japan Co., Ltd., (guest compound: silicon compound), and CopyCharge N5P01, a trade name, available from the same company, (guest compound: magnesium compound). The amount of the compound used is generally from 0.01 to 10 parts by weight per 100 parts by weight of the resin contained in the toner.

The amount of fine powder having a particle diameter of 4 μm or less in the toner is preferably suppressed to 5.5% by population, whereby occurrence of fine powder in the toner of the developer, which is liable to increase during life, can be suppressed, and charge failure due to spent of the toner on a carrier and deterioration of the flowability of the developer are suppressed to attain a prolonged service life. By using the developer, a high definition image with high quality and less fogging can be obtained under a wide range of environmental conditions.

With respect to fogging under environment of a low temperature and a low humidity, it is important to decrease a part with small charge amount. It is preferred therefor that silica having a relatively large particle diameter of about from 20 to 40 nm is used.

A carrier having a small particle diameter is being used for achieving high image quality in recent years, which brings about deterioration in flowability. The use of the silica having a large particle diameter improves the flowability and is effective for decreasing a part with small charge amount.

The silica having a particle diameter about from 20 to 40 nm is effective for improving the flowability. Furthermore, for attaining the toner recycling system mentioned above, it is necessary to ensure flowability of the recycled toner. It is difficult to optimize the flowability of the recycled toner only with the silica having a particle diameter of about from 20 to 40 nm. Accordingly, the silica having a relatively small particle diameter of about from 8 to 14 nm is used in combination, thereby avoiding the difficulty.

In the recycling system, titanium oxide is accumulated, and when the amount thereof exceeds a certain level, image failure may occur. Accordingly, the amount of titanium oxide added to the toner is preferably from 0.15 to 1.2 parts by weight per 100 parts by weight of the toner. When the amount of titanium oxide added to the toner is in that rage, the amount of titanium oxide in the toner is about 1.5 parts by weight at most in the saturated state, thereby decreasing the proportion of the weakly charged and inversely charged toners.

According to the aforementioned constitutions, a toner having a prolonged service life can be provided.

The aforementioned embodiments are described for the case where the toner of the invention is applied to an electrophotographic duplicator using the toner recycling system. However, the invention can be applied not only to an apparatus using the toner recycling system, but also to an ordinary electrophotographic duplicator that does not reuse the toner. The toner of the invention may also be applied to such an image forming apparatus that uses a two-component developer containing a toner and a carrier mixed therewith, and reuses not only the toner but also the carrier.

The aforementioned embodiments are described for the case using a two-component developer containing a powder toner and a carrier. However, the invention can be applied not only to a two-component developer but also to a one-component developer containing a toner only.

The toner of the invention may be applied not only to a duplicator but also to a multifunctional peripheral (MFP), and in general, can be applied to any apparatus that has a duplicating function utilizing electrophotography (duplicator).

Obviously, many modifications and variations of the invention are possible in the light of the above teachings. It is therefore to be understood that within the scope of the appended claims, the invention may be practiced otherwise than as specification.

What is claimed is:

1. An electrophotographic toner comprising 100 parts by weight of a toner resin, from 0.01 to 10 parts by weight of a cyclodextrin compound, first silica having an average particle diameter of from 20 to 40 nm, and second silica having an average particle diameter of from 8 to 14 nm.

2. The toner as claimed in claim 1, wherein the toner has an amount of fine powder having a particle diameter of 4 μm or less of 5.5% by population or less.

3. An electrophotographic toner used in a toner recycling system that reuses the toner,
the toner comprising 100 parts by weight of a toner resin, from 0.01 to 10 parts by weight of a cyclodextrin compound, first silica having an average particle diameter of from 20 to 40 nm, second silica having an average particle diameter of from 8 to 14 nm, and from 0.15 to 1.2 parts by weight of titanium oxide per 100 parts by weight of the toner.

4. The toner as claimed in claim 3, wherein the toner has an amount of fine powder having a particle diameter of 4 μm or less of 5.5% by population or less.

5. An image forming apparatus comprising a latent image forming part that forms an electrostatic latent image through selective exposure on a photoconductor drum, and a developing part that develops the electrostatic latent image, which is formed by the latent image forming part, with a developer to provide an image,
the developer including an electrophotographic toner containing 100 parts by weight of a toner resin, from 0.01 to 10 parts by weight of a cyclodextrin compound, first silica having an average particle diameter of from 20 to 40 nm, and second silica having an average particle diameter of from 8 to 14 nm.

6. The apparatus as claimed in claim 5, wherein the developer further comprises, in addition to the toner, a carrier mixed with the toner.

7. An image forming apparatus comprising a latent image forming part that forms an electrostatic latent image through selective exposure on a photoconductor drum, and a developing part that develops the electrostatic latent image, which is formed by the latent image forming part, with a developer to provide an image, and reusing the developer,
the developer including an electrophotographic toner containing 100 parts by weight of a toner resin, from 0.01 to 10 parts by weight of a cyclodextrin compound, first silica having an average particle diameter of from 20 to 40 nm, second silica having an average particle diameter of from 8 to 14 nm, and from 0.15 to 1.2 parts by weight of titanium oxide per 100 parts by weight of the toner.

8. The apparatus as claimed in claim 7, wherein the developer further comprises, in addition to the toner, a carrier mixed with the toner.

9. The apparatus as claimed in claim 8, wherein the toner has an amount of fine powder having a particle diameter of 4 μm or less of 5.5% by population or less.
